(19) United States
(12) Patent Application Publication
(10) Pub. No.: US 2026/0098957 A1
(43) Pub. Date: Apr. 9, 2026

(54) Device for Determining the Distance Between a Base and a Mobile Entity Using Time of Flight

(71) Applicant: Continental Automotive Technologies GmbH, Hannover (DE)

(72) Inventors: Stéphane BILLY, Grenade (FR); Sylvain GODET, Villeneuve-lès-Bouloc (FR)

(73) Assignee: Continental Automotive Technologies GmbH, Hannover (DE)

(21) Appl. No.: 19/349,014

(22) Filed: Oct. 3, 2025

(30) Foreign Application Priority Data
Oct. 4, 2024 (FR) FR2410759

(51) Int. Cl. G01S 13/76; G01S 13/58

(52) U.S. Cl. CPC G01S 13/76; G01S 13/58

(57) ABSTRACT

A device for determining the distance between a base and a mobile entity. The base includes time-of-flight-based distance-measuring, in which the device includes: speed-measuring capable of determining the speed of the mobile entity relative to the base; a controller capable of determining a number of time-of-flight measurements as a decreasing function of the speed of the mobile entity, and of causing the distance-measuring to carry out a number of time-of-flight measurements so as to obtain the same number of elementary distance measurements; a filter capable of determining the distance by calculating the median of the elementary distance measurements.

### CROSS-REFERENCE TO RELATED APPLICATIONS

This application claims priority to FR2410759, filed Oct. 4, 2024, the contents of such application being incorporated by reference herein.

### FIELD OF THE INVENTION

The invention relates to a device and a method for determining the distance between a base and a mobile entity using time of flight.

### BACKGROUND OF THE INVENTION

It is known to use time-of-flight measurements in order to determine a distance between a base and a mobile entity.

For this purpose, a wave, for example a radiofrequency wave, is transmitted by the base. This wave is reflected by the mobile entity. The reflected wave is received by the base. The base measures the time interval between the transmission and the return of the wave and is thus able, with the propagation speed being known, to deduce the distance therefrom using the formula d=(tr−té)/2v, where d is the distance sought, tr is the date of return of the wave, té is the date of transmission of the wave and v is the propagation speed.

The distance measurement is marred by errors. Thus, for a time-of-flight device using UWB modulation, the error on a single measurement is +/−20 cm, this being insufficient for some applications.

One technique that makes it possible to improve the accuracy of the distance measurement consists in carrying out multiple measurements and carrying out average or median filtering on these measurements. The greater the number of measurements, the greater the accuracy, but the greater the response time as well. Many applications cannot tolerate such an increase in response time.

An alternative means for determining the distance d between a base and a mobile entity is thus sought that makes it possible to improve accuracy without degrading response time.

### SUMMARY OF THE INVENTION

For this purpose, an aspect of the invention proposes a determination process the accuracy of which varies dynamically as a function of the time available.

One aspect of the invention is a device for determining the distance between a base and a mobile entity, the base comprising a time-of-flight-based distance-measuring means, in which the device comprises:
a speed-measuring means capable of determining the speed of the mobile entity relative to the base,
a control means capable of determining a number of time-of-flight measurements as a decreasing function of the speed of the mobile entity, and of causing the distance-measuring means to carry out a number of time-of-flight measurements so as to obtain the same number of elementary distance measurements,
a filtering means capable of determining the distance by calculating the median of the elementary distance measurements.

The following are particular features or embodiments, which may be used alone or in combination:
the decreasing function of the speed is the quotient of a reference speed and the speed of the mobile entity,
the reference speed is the speed that makes it possible to cover a reference distance, preferably equal to 0.5 m, in a compound sampling period of the time-of-flight measurements, preferably equal to an elementary sampling period, equal to 96 ms,
the distance-measuring means comprises a plurality of antennas and the device for determining the distance furthermore comprises a cycling means, capable of cyclically using the antennas to produce the same number of elementary distance pre-measurements, and determine an elementary distance measurement equal to the minimum value of the elementary distance pre-measurements,
the cycling means cyclically uses the antennas in accordance with the elementary sampling period, and the number of time-of-flight measurements and elementary distance measurements is calculated on the basis of a compound sampling period equal to the elementary sampling period multiplied by the number of antennas,
the speed-measuring means comprises a radar, arranged on the base,
the speed-measuring means comprises a sensor arranged on the mobile entity, and a communication means capable of transmitting the speed to the base,
the distance-measuring means comprises a radiofrequency transceiver using ultra-wideband, UWB, modulation,
the radar is merged with the radiofrequency transceiver, configured in radar mode,
the communication means is merged with the radiofrequency transceiver combined with a homologous radiofrequency transceiver, arranged on the mobile entity.

### BRIEF DESCRIPTION OF THE DRAWINGS

Aspects of the invention will be better understood from reading the following description, which is provided solely by way of an example, and with reference to the accompanying figures, in which:

FIG. 1 shows an overview of the context of an aspect of the invention,

FIG. 2 shows a table for determining the number of measurements as a function of the speed of the mobile entity, according to a first embodiment,

FIG. 3 shows a table for determining the number of measurements as a function of the speed of the mobile entity, according to another embodiment.

### DESCRIPTION OF THE EMBODIMENTS

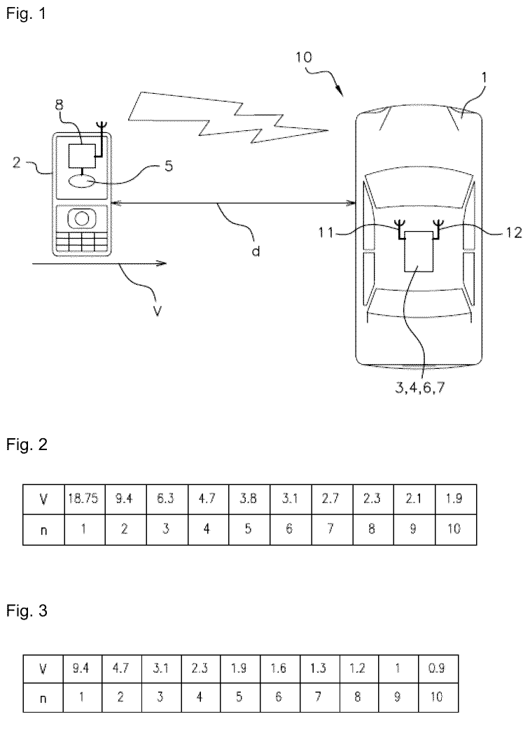

With reference to FIG. 1, an aspect of the invention relates to a device 10 for determining the distance d between a base 1 and a mobile entity 2.

In one illustrative application of an aspect of the invention, the base 1 is a motor vehicle and the mobile entity 2 is the user of the motor vehicle, represented more specifically by their smartphone. The application aims to determine the distance between the base 1 and the mobile entity 2, in order to carry out or not carry out certain motor vehicle access control functions as a function of the distance between the base 1 and the mobile entity 2. Thus, as long as the user is more than 2 m away from the vehicle, authorization should not be given. When the user approaches, and at the latest when they touch the door handle, authorization should be granted to them.

To this end, the base 1 comprises a time-of-flight-based distance-measuring means 3.

According to one feature, the device 10 furthermore comprises a speed-measuring means, a control means and a filtering means. The speed-measuring means is capable of determining the relative speed v of the mobile entity 2 with respect to the base 1. The control means is capable of determining a number of time-of-flight measurements n as a decreasing function of the speed v of the mobile entity 2. The control means is also capable of causing the distance-measuring means 3 to carry out a number of time-of-flight measurements n. These n time-of-flight measurements make it possible to obtain the same number n of distance measurements di, with i between 1 and n. The filtering means is capable of determining the distance d, from n distance measurements di, by calculating the median.

Since the number of time-of-flight measurements n is a decreasing function of the speed v of the mobile entity 2, the response time and the accuracy of the distance measurement d depend directly on the time available. If the mobile entity 2 is moving rapidly, the time available is short. A measurement of the distance d is therefore carried out with few distance measurements di, thereby guaranteeing a short response time, at the expense of accuracy. On the contrary, if the mobile entity 2 is moving more slowly, the time available is greater. A measurement of the distance d is therefore carried out with a larger number of distance measurements di, thereby guaranteeing improved accuracy, at the expense of the longer response time.

The idea of using a decreasing function of speed v to determine the number n of time-of-flight measurements makes it possible to adapt the number of time-of-flight measurements n dynamically. Indeed, the faster the mobile entity 2 is moving, the less time the device 10 has to update the distance d, which varies more rapidly. In this case, the number n decreases, as does the accuracy of the measurement of the distance d. However, an optimized measurement, which is as accurate as possible in the time available, is provided with a minimum delay.

On the other hand, when the mobile entity 2 is moving more slowly, the device 10 has more time to update the distance d, which varies less rapidly. In this case, the number n increases, and the accuracy of the measurement of the distance d improves alongside. The device 10 thus provides an optimized distance measurement with increased accuracy, taking into account the greater amount of time available. The delivery delay is slightly increased, but without any adverse consequences, since the distance d also varies less rapidly.

The decreasing function of the speed v may be any decreasing function.

According to another feature, the decreasing function of the speed v is the quotient of a reference speed v₀ and the speed v of the mobile entity 2. The curve of this function is thus a hyperbola. Written in mathematical terms, this function f of the variable v is written n=f(v)=v₀/v. In this formula, n is the number of time-of-flight measurements, v is the speed v of the mobile entity 2 and v₀ is a reference speed, which is constant for an application.

According to another feature, the reference speed v₀ is determined as follows. A reference distance do in relation to the application is chosen. The reference speed v₀ is then the speed that makes it possible to cover the reference distance d₀ in the time needed to determine an elementary distance di, that is to say a time that will be called the compound sampling period Te′.

In the illustrative application of determining the distance of a user from their vehicle, the significant event is when the user grips the vehicle door handle. This event is characterized by a distance d between the mobile entity 2/smartphone, which is assumed to be carried in a pocket level with the waist or chest, and the base 1/vehicle, substantially equal to the length of the user's forearm. Therefore, in this illustrative application, the reference distance d₀ is chosen to be equal to 50 cm.

Remaining in the illustrative application, the compound sampling period Te′ is a multiple of an elementary sampling period Te. Assuming a single antenna 11, the multiplication factor is equal to 1, as explained below. The elementary sampling period Te is constrained, by compliance with the CCC standard, to a value of 96 ms or 0.096 s. Therefore, the compound sampling period Te′ is equal to 96 ms here. As a result, the reference speed v₀=d₀/Te′ is in this case equal to 0.5/0.096, that is to say equal to 5.2 m/s or 18.75 km/h.

This means that, in the illustrative application, the number n of elementary distance measurements di as a function of the speed v, in km/h, of the mobile entity 2 is given by the table shown in FIG. 2. For an intermediate speed between two values, the smallest value of n is selected. Thus, for example, for a speed of 3 km/h, which is between the bounds 3.1 and 2.7 km/h, the number n of measurements is taken to be equal to the lower value, that is to say n=6.

According to another feature, the distance-measuring means 3 comprises a plurality of antennas 11, 12. The device 10 may operate with a single antenna 11, as described above. However, one or more additional antennas 12 make it possible to create spatial diversity, which makes it possible to improve the accuracy of an elementary distance measurement di. In order to take advantage of this spatial diversity, the device 10 for determining the distance d furthermore comprises a cycling means. This cycling means is capable of cyclically using each of the antennas 11, 12 to produce, with each of them, a distance pre-measurement dⱼ, with the index j varying from 1 to p, where p is the number of antennas 11, 12. A distance pre-measurement dj is derived from a time-of-flight measurement, as described above. For all antennas 11, 12, an elementary distance measurement di, equal to the minimum value of the respective distance pre-measurements dj, is determined. Indeed, it may be considered that the antennas 11, 12 are close enough for their respective propagation to be considered identical. It is then mainly the presence or absence of multi-path that distinguishes them from one another. Therefore, the minimum distance is closest to the actual distance. Next, the elementary distance measurements di are processed substantially as before.

When there is more than one antenna, each of the antennas 11, 12 is used in turn, in accordance with an elementary sampling period Te. This means that the compound sampling period Te′, corresponding to obtaining an elementary measurement di, is equal to an elementary sampling period Te multiplied by the number p of antennas 11, 12, that is to say Te′=Te*p.

The number of time-of-flight measurements n should therefore be adjusted accordingly. According to another feature, the number of time-of-flight measurements n is calculated on the basis of a compound sampling period Te′. This compound sampling period Te′ is equal to the elementary sampling period Te multiplied by the number p of antennas 11, 12. The reference speed v₀=d₀/Te′=d₀/(p·Te) is thereby divided by p·n is modified accordingly.

Thus, in the illustrative application, the elementary sampling period Te is constrained, by compliance with the CCC standard, to a value of 96 ms or 0.096 s. Therefore, the compound sampling period Te′ is then equal to 192 ms. As a result, the reference speed v₀=d₀/Te′ is in this case equal to 0.5/0.192, that is to say equal to 2.6 m/s or 9.4 km/h.

This means that, in the illustrative application, the number n of elementary distance measurements di as a function of the speed v, in km/h, of the mobile entity 2 is given by the table shown in FIG. 3.

There are at least two ways of determining the speed v of the mobile entity 2. The first is to use a radar arranged on the base 1. The second is to measure the speed v using a sensor arranged on the mobile entity 2. Since all calculations are preferably carried out on the base 1, it is then necessary to transmit the speed measurement v obtained on the mobile entity 2 from the mobile entity 2 to the base 1. This is done using a communication means 6.

In the first case, the speed-measuring means comprises a radar 4. This radar 4 may be of any type: radio, ultrasound, laser, etc. The radar 4 is arranged on the base 1. It transmits a wave in the direction of the mobile entity 2 and analyzes the reflected wave to determine, typically using the Doppler effect, the speed v of the mobile entity 2.

In the second case, the speed-measuring means comprises a sensor 5 arranged on the mobile entity 2. This sensor 5 may be of any type that makes it possible to measure a speed v of the mobile entity 2 carrying the sensor 5. A communication means 6 then transmits the speed v to the base 1. This communication means 6 typically comprises a transmitter embedded in the mobile entity 2 and an associated receiver embedded in the base.

According to another feature, in the case where the mobile entity 2 is a smartphone, the sensor 5 advantageously reuses the position/orientation/speed sensor of said smartphone, or IMU (inertial measurement unit).

According to another feature, the distance-measuring means 3 comprises a radiofrequency transceiver 7 using ultra-wideband, UWB, modulation. Such equipment makes it possible to carry out time-of-flight measurements.

According to another feature, the radar 4 reuses said radiofrequency transceiver 7. In this case, the radiofrequency transceiver 7 is configured in radar mode so as to be able to measure the speed v of the mobile entity 2 using the Doppler effect.

The communication means 6 may be of any type and use any technology capable of transmitting a measurement. According to another feature, the communication means 6 reuses the radiofrequency transceiver 7 of the base 1 and combines it with a homologous radiofrequency transceiver 8 arranged on the mobile entity 2.

The invention has been illustrated and described in detail in the drawings and the preceding description. This should be considered to be illustrative and is provided by way of an example and not as limiting the invention to this description alone. Many alternative embodiments are possible.

### LIST OF REFERENCE SIGNS

1: base,
2: mobile entity,
3: time-of-flight-based measuring device,
4: radar,
5: sensor,
6: communication means,
7: base transceiver,
8: mobile entity transceiver,
10: distance-determining device,
11, 12: antennas,
d: base/mobile entity distance,
d₀: reference distance,
di: elementary distance measurement,
dj: elementary distance pre-measurement,
p: number of antennas,
Te: elementary sampling period,
Te′: compound sampling period,
v: relative speed of the mobile entity,
v₀: reference speed.

1. A device for determining the distance between a base and a mobile entity the base comprising a time-of-flight-based distance-measuring means , comprising:
a speed-measuring means capable of determining the speed of the mobile entity relative to the base,
a control means capable of determining a number of time-of-flight measurements as a quotient of a reference speed and the speed of the mobile entity, and of causing the distance-measuring means to carry out a number of time-of-flight measurements so as to obtain the same number of elementary distance measurements,
a filtering means capable of determining the distance by calculating the median of the elementary distance measurements.

2. The device as claimed in claim 1, in which the reference speed is the speed that makes it possible to cover a reference distance, preferably equal to 0.5 m, in a compound sampling period of the time-of-flight measurements, preferably equal to an elementary sampling period, equal to 96 ms.

3. The device as claimed in claim 1, in which the distance-measuring means comprises a plurality of antennas and in which the device for determining the distance furthermore comprises a cycling means, capable of cyclically using the antennas to produce the same number of elementary distance pre-measurements, and determine an elementary distance measurement equal to the minimum value of the elementary distance pre-measurements.

4. The device as claimed in claim 3, in which the cycling means cyclically uses the antennas in accordance with the elementary sampling period, and in which the number of time-of-flight measurements and elementary distance measurements is calculated on the basis of a compound sampling period (Te′) equal to the elementary sampling period multiplied by the number of antennas.

5. The device as claimed in claim 1, in which the speed-measuring means comprises a radar, arranged on the base.

6. The device as claimed in claim 1, in which the speed-measuring means comprises a sensor arranged on the mobile entity, and a communication means capable of transmitting the speed to the base.

7. The device as claimed in claim 1, in which the distance-measuring means comprises a radiofrequency transceiver using ultra-wideband, UWB, modulation.

8. The device as claimed in claim 7, in which the radar is merged with the radiofrequency transceiver, configured in radar mode.

9. The device as claimed in claim 7, in which the communication means is merged with the radiofrequency transceiver combined with a homologous radiofrequency transceiver, arranged on the mobile entity.

10. A method for determining the distance between a base and a mobile entity, the base comprising a time-of-flight-based distance-measuring means , the method comprising:
determining the speed of the mobile entity relative to the base,
determining a number of time-of-flight measurements as a quotient of a reference speed and the speed (v) of the mobile entity,
commanding the distance-measuring means to carry out a number of time-of-flight measurements so as to obtain the same number of elementary distance measurements (di), and
determining the distance by calculating the median of the elementary distance measurements.

12. The device as claimed in claim 2, in which the distance-measuring means comprises a plurality of antennas and in which the device for determining the distance furthermore comprises a cycling means, capable of cyclically using the antennas to produce the same number of elementary distance pre-measurements, and determine an elementary distance measurement equal to the minimum value of the elementary distance pre-measurements.

13. The device as claimed in claim 8, in which the communication means is merged with the radiofrequency transceiver combined with a homologous radiofrequency transceiver, arranged on the mobile entity.
